(19) United States
(12) Patent Application Publication
(10) Pub. No.: US 2025/0178336 A1
(43) Pub. Date: Jun. 5, 2025

(54) LIQUID DISCHARGE HEAD, HEAD MODULE, AND LIQUID DISCHARGE APPARATUS

(71) Applicant: Takeshi MIYAZAKI, Kanagawa (JP)

(72) Inventor: Takeshi MIYAZAKI, Kanagawa (JP)

(21) Appl. No.: 18/937,062

(22) Filed: Nov. 5, 2024

(30) Foreign Application Priority Data
Nov. 30, 2023 (JP) 2023-202959

(51) Int. Cl. B41J 2/045; B41J 2/14

(52) U.S. Cl. CPC B41J 2/04505; B41J 2/14233

(57) ABSTRACT

A liquid discharge head includes a nozzle member including a plurality of nozzles to discharge liquid and a blow-out hole to blow out gas. The blow-out hole is closer to an end in a longitudinal direction of the nozzle member than a nozzle closest to the end in the longitudinal direction of the nozzle member among the plurality of nozzles is.

### CROSS-REFERENCE TO RELATED APPLICATION

This patent application is based on and claims priority pursuant to 35 U.S.C. §119(a) to Japanese Patent Application No. 2023-202959, filed on Nov. 30, 2023, in the Japan Patent Office, the entire disclosure of which is hereby incorporated by reference herein.

### BACKGROUND

### Technical Field

The present disclosure relates to a liquid discharge head, a head module, and a liquid discharge apparatus.

### Related Art

A liquid discharge head accurately lands liquid from each nozzle to a predetermined position on a recording medium, whereby a desired image can be formed on the recording medium.

However, the landing position of the liquid is disadvantageously displaced due to the influence of the gas flow generated by discharging the liquid.

For such a disadvantage, for example, a liquid discharge head includes a gas flow blow-out part that blows out a gas flow toward a recording medium. The gas flow blow-out part includes a main gas-flow blowing outlet and a sub gas-flow blowing outlet. These outlets surround a nozzle array as an array of nozzles that discharge ink. The gas flow blow-out part is different in member from a nozzle plate including the nozzles, and protrudes toward the recording medium from the nozzle plate.

### SUMMARY

The present disclosure described herein provides a liquid discharge head that includes a nozzle member including a plurality of nozzles to discharge liquid and a blow-out hole to blow out gas. The blow-out hole is closer to an end in a longitudinal direction of the nozzle member than a nozzle closest to the end in the longitudinal direction of the nozzle member among the plurality of nozzles is.

The present disclosure described herein also provides a head module including a plurality of liquid discharge heads, each one of which is the liquid discharge head.

The present disclosure described herein further provides a liquid discharge apparatus including the liquid discharge head.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a plan view of a nozzle face of a liquid discharge head according to an embodiment of the present disclosure;

FIG. 2 is a cross-sectional view taken along line A1-A1 of FIG. 1;

FIG. 3 is a cross-sectional view taken along line A2-A2 in FIG. 2;

FIG. 4 is a cross-sectional view taken along line A3-A3 of FIG. 3;

FIG. 5 is a perspective view of a side opposite to the nozzle face side of the liquid discharge head;

FIG. 6A is a plan view of a nozzle face of a liquid discharge head different from the nozzle face of the liquid discharge head of the embodiment of the present disclosure;

FIG. 6B is a cross-sectional view taken along line A4-A4 of FIG. 6A;

FIG. 7A is a plan view of the nozzle face of the liquid discharge head according to the embodiment of the present disclosure;

FIG. 7B is a cross-sectional view taken along line A5-A5 of FIG. 7A;

FIG. 8A is a plan view of a nozzle face of a liquid discharge head of an embodiment different from the above;

FIG. 8B is a cross-sectional view taken along line A6-A6 of FIG. 8A;

FIG. 9 is a plan view of a nozzle face of a liquid discharge head of an embodiment different from the above;

FIG. 10 is a plan view of a nozzle face of a liquid discharge head of an embodiment different from the above;

FIG. 11 is an exploded perspective view of a head module;

FIG. 12 is a schematic view of a liquid discharge apparatus according to embodiments of the present disclosure;

FIG. 13 is a cross-sectional view of a head unit provided to the liquid discharge apparatus of FIG. 12; and

FIG. 14 is a schematic view of a liquid discharge apparatus different from the liquid discharge apparatus in FIG. 12.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings. Note that identical parts are given identical reference signs and redundant descriptions are summarized or omitted accordingly. In the following description, a liquid discharge head that discharge ink as an exemplary liquid is described.

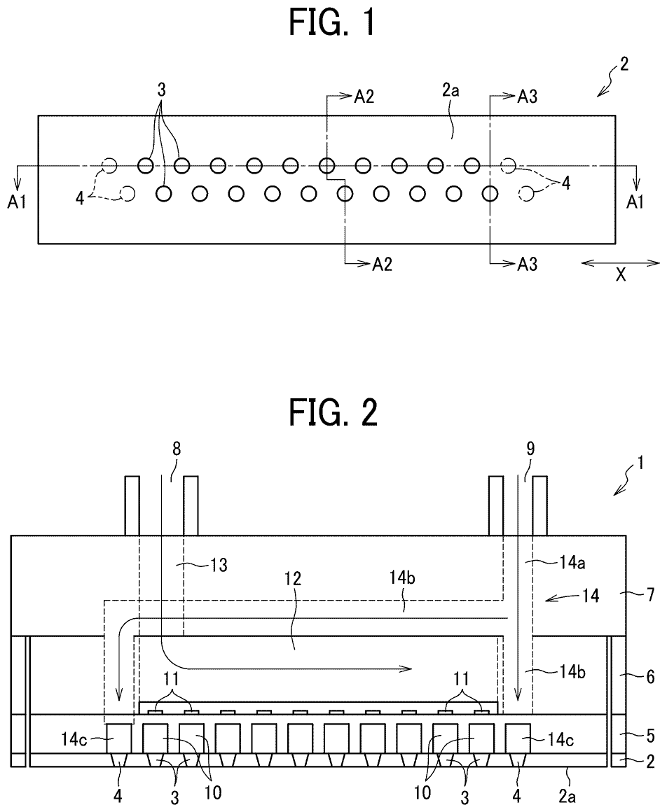

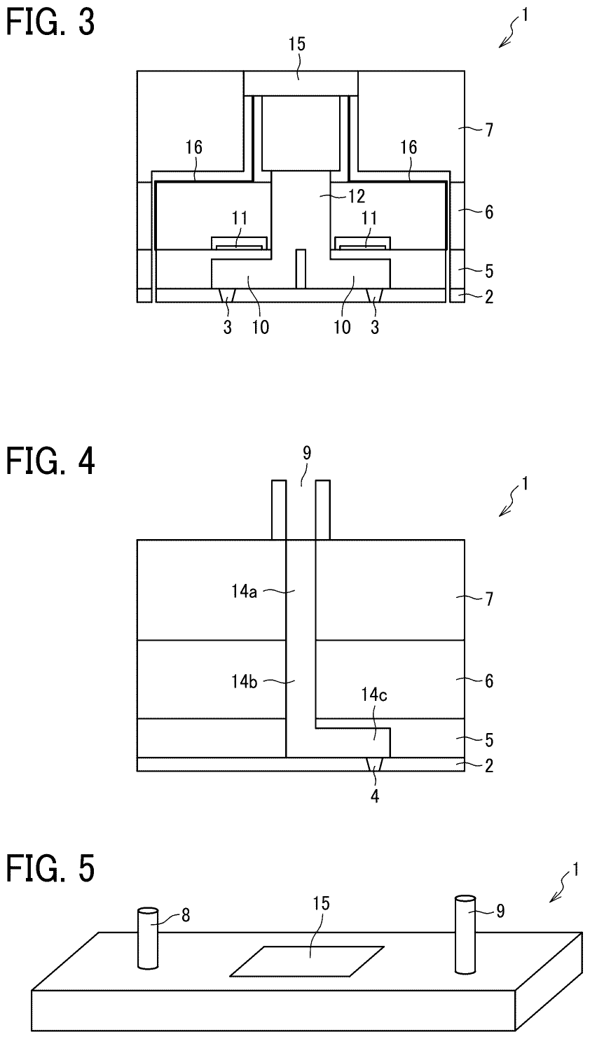

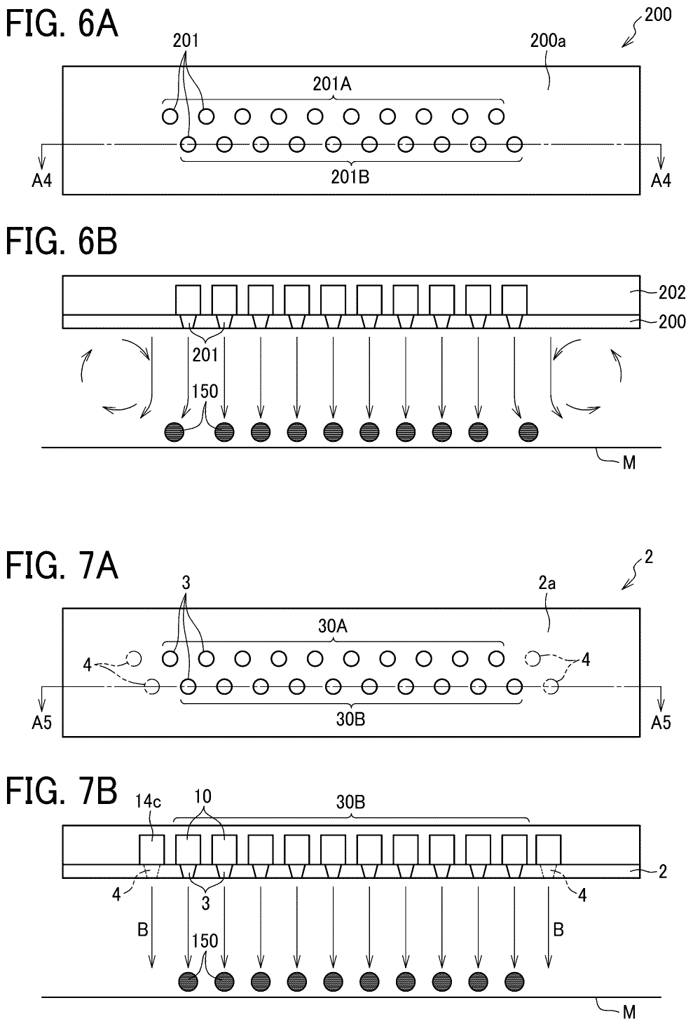

A liquid discharge head according to an embodiment of the present disclosure is described with reference to FIGS. 1 to 5. FIG. 1 illustrates a nozzle face 2a side of a nozzle plate 2 provided to a liquid discharge head 1. FIG. 2 is a cross-sectional view taken along line A1-A1 of FIG. 1. FIG. 3 is a cross-sectional view taken along line A2-A2 of FIG. 1. FIG. 4 is a cross-sectional view taken along line A3-A3 of FIG. 1. FIG. 5 is a perspective view of a side opposite to the nozzle face 2a side of the liquid discharge head 1. The arrow X direction in FIG. 1 is the longitudinal direction of the nozzle plate 2. The longitudinal direction is an array direction of nozzles. The up-and-down direction in FIG. 1 orthogonal to the arrow X direction is the lateral direction of the nozzle plate 2.

As illustrated in FIG. 1, the nozzle plate 2 as a nozzle member includes a plurality of nozzles 3 and a plurality of blow-out holes 4. The nozzle face 2a of the nozzle plate 2 illustrated in FIG. 1 is a face provided with an end on the ink discharge side of the nozzles 3. The nozzle face 2a is also provided with another end on the gas blow-out side of the blow-out holes 4.

As illustrated in FIGS. 2 and 3, the liquid discharge head 1 includes the nozzle plate 2, an individual liquid chamber substrate 5, a common liquid chamber substrate 6, a housing 7, a liquid port 8, a gas port 9, for example. The individual liquid chamber substrate 5 forms each individual liquid chamber 10 in communication with the corresponding nozzle 3 and each individual supply channel in communication with the corresponding individual liquid chamber 10. Each piezoelectric element 11 as a pressure generating member is provided facing the corresponding individual liquid chamber 10. The common liquid chamber substrate 6 forms a common liquid chamber 12 in communication with each individual liquid chamber 10 through the corresponding individual supply channel. The housing 7 forms a common supply channel 13 in communication with the common liquid chamber 12. The common supply channel 13 is communication with the liquid port 8 on the side opposite to the common liquid chamber 12 side. As illustrated in FIGS. 3 and 5, the housing 7 has an upper portion provided with the liquid port 8, the gas port 9, and an electric interface (I/F) 15. The electric I/F 15 of the present embodiment includes a printed circuit board (PCB) and a connector mounted thereon. As illustrated in FIG. 3, each piezoelectric element 11 is electrically connected to the electric I/F 15 through a wiring board 16. As illustrated in FIGS. 2 and 4, the housing 7, the common liquid chamber substrate 6, and the individual liquid chamber substrate 5 form a gas path 14 through which gas is supplied from the gas port 9 to each blow-out hole 4. The gas path 14 includes a gas common path 14a, a gas branch path 14b, and a gas individual path 14c in communication with the gas port 9. Each blow-out hole 4 blows out the gas supplied from the gas port 9 and does not discharge ink. As a method of blowing out the gas from the blow-out hole 4, for example, an appropriate gas flow generating mechanism such as an air pump or an air compressor is provided on the gas port 9 side, and the gas flow generating mechanism can blow out the gas such as compressed air from the blow-out hole 4 through the gas port 9 and the gas path 14.

A liquid discharge head that discharge liquid from its nozzle to a recording medium to form an image has a disadvantage in that the liquid discharged from the nozzle flows due to, for example, the gas flow generated in response to the liquid discharge, resulting in displacement of the landing position of the liquid on the recording medium. This disadvantage is described with reference to FIGS. 6A and 6B. FIGS. 6A and 6B illustrate a nozzle plate 200 of a liquid discharge head different in configuration from the present embodiment. FIG. 6A is a plan view of a nozzle face 200a as a face on the ink discharge side of the nozzle plate 200. FIG. 6B is a cross-sectional view taken along line A1-A1 of FIG. 6A.

The nozzle plate 200 illustrated in FIG. 6A includes a nozzle array 201A and a nozzle array 201B in two rows in the lateral direction of the nozzle plate 200, as nozzle arrays each including a plurality of nozzles 201 disposed in the longitudinal direction of the nozzle plate 200. The nozzles 201 are alternately disposed in the longitudinal direction in the upper and lower nozzle arrays 201A and 201B.

As illustrated in FIG. 6B, in the region where the nozzles 201 in the longitudinal direction are disposed, a downward gas flow is generated due to ink discharge. However, such a gas flow is not generated outside the region where the nozzles 201 are disposed. Thus, as indicated by the arrows in FIG. 6B, the vortex of a gas flow circulating clockwise is generated around the boundary between the region where the nozzles 201 are disposed and the outside of the region. A recording medium M such as a paper sheet is conveyed opposite to the nozzle plate 200. A gas flow is also generated due to the conveyance of the recording medium M. In particular, conveyance of the recording medium M in a direction parallel to the longitudinal direction exerts influence such as promoting the above-described clockwise circulating gas flow.

Due to the influence of the gas flow, in particular, the landing position of ink 150 discharged from each nozzle 201 disposed closest to the corresponding end in the longitudinal direction among the nozzles 201 of the nozzle arrays 201A and 201B is displaced outside in the longitudinal direction. This displacement causes an abnormal image formation such as density unevenness or streaks of an image formed on the recording medium M. In particular, in the case of a liquid discharge head having a large printing gap as the distance between the nozzle face and a recording medium M, a gas flow easily exerts influence on the ink discharged from the nozzles. Thus, the displacement of the landing position of the ink due to the influence of the gas flow is remarkable. Examples of the large printing gap includes a printing gap larger than 5 mm.

The configuration of the present embodiment for inhibiting the displacement of the landing position of the ink due to the influence of the gas flow is described with reference to FIGS. 7A and 7B below.

As illustrated in FIG. 7A, similarly to the above-described nozzle plate 200, a plurality of nozzle arrays 30A and 30B is disposed on the nozzle plate 2. The nozzles 3 are alternately disposed in the longitudinal direction in the nozzle arrays 30A and 30B. However, the disposition of the nozzles of the nozzle member of the present disclosure is not limited the disposition described above. Therefore, one or at least three nozzle arrays may be disposed, the nozzles may be disposed in a row in the longitudinal direction, or the nozzles may be irregularly disposed.

The nozzle plate 2 of the present embodiment is different from the nozzle plate 200 in that the nozzle plate 2 includes the blow-out holes 4 that blow out gas and the blow-out holes 4 are each provided closer to the corresponding end in the longitudinal direction of the nozzle plate 2 than the corresponding nozzle 3 is, the corresponding nozzle 3 being disposed closest to the corresponding end in the longitudinal direction of the nozzle plate 2 among the plurality of nozzles 3. In FIGS. 7A and 7B, the blow-out holes 4 are indicated by the two-dot chain lines for convenience. The blow-out holes 4 are each provided particularly at the corresponding end of the nozzle face 2a and closer to the corresponding end of the nozzle face 2a than the corresponding nozzle 3 is. In the present embodiment, the nozzles 3 and the blow-out holes 4 extend in a direction substantially perpendicular to the nozzle face 2a. In the embodiment of FIG. 7A, two blow-out holes 4 are provided outside the nozzles 3 of the nozzle array 30A one-to-one at both ends of the nozzle array 30A and two blow-out holes 4 are provided outside the nozzles 3 of the nozzle array 30B one-to-one at both ends of the nozzle array 30B in the longitudinal direction.

As illustrated in FIG. 7B, gas is blown out from the blow-out holes 4 toward a recording medium M in the arrow B direction. That is, a gas flow in the arrow B direction is formed at each position of the clockwise gas flow illustrated in FIG. 6B or a position corresponding to the vicinity of each position of the clockwise gas flow illustrated in FIG. 6B. This formation of the gas flow in the arrow B direction inhibits the displacement in the discharge direction of ink discharged from each of the outermost nozzles 3, namely, the displacement of the landing position as illustrated in FIG. 7B. Therefore, density unevenness and an abnormal image due to the displacement of the landing position of the ink can be inhibited. In the present embodiment, the blow-out holes 4 are provided to the nozzle plate 2. This arrangement eliminates providing a separate member for forming the blow-out holes 4, resulting in reduction of the liquid discharge head 1 in cost and size. The provided blow-out holes 4 do not exert influence on maintainability of the liquid discharge head 1. That is, as compared with a case where the blow-out holes 4 are provided to a member different from the nozzle plate 2, there is no adverse influence such as complication of a wiping operation and a suction operation for the nozzles 3, and in the present embodiment, the blow-out holes 4 can be wiped simultaneously by the wiping operation for the nozzles 3.

In the present embodiment, the blow-out holes 4 are substantially equal in diameter to the nozzles 3. Thus, the nozzle plate 2 can be easily processed, and the blow-out holes 4 can be formed with a highly accurate dimension.

In the present embodiment, the blow-out holes 4 are provided on both outer sides in the longitudinal direction. This arrangement inhibits the influence of the gas flow on the nozzles 3 disposed closest to both ends in the longitudinal direction. However, the blow-out holes of the present disclosure are not necessarily provided on both sides in the longitudinal direction. For example, in a case where the influence of a gas flow is small and the displacement of the landing position of liquid is small on one side in the longitudinal direction, a blow-out hole may be provided only on the other side.

As illustrated in FIG. 2, the gas path 14 through which gas is supplied from the gas port 9 to the blow-out holes 4 is formed by the housing 7, the common liquid chamber substrate 6, and the individual liquid chamber substrate 5. The housing 7, the common liquid chamber substrate 6, and the individual liquid chamber substrate 5 are channel members forming a liquid channel including, for example, a common supply channel and an individual supply channel for supplying ink from the liquid port 8 to the nozzles 3. Forming a path for ink supply and a path for gas supply using a common member results in reduction of the liquid discharge head in size and cost. A gas path is not necessarily formed by all of the housing 7, the common liquid chamber substrate 6, and the individual liquid chamber substrate 5, namely, all of the channel members. Thus, the gas path may be formed only by individual liquid chamber substrate 5, for example.

Next, modifications of the liquid discharge head different in, for example, the disposition of the blow-out holes 4 is described in order.

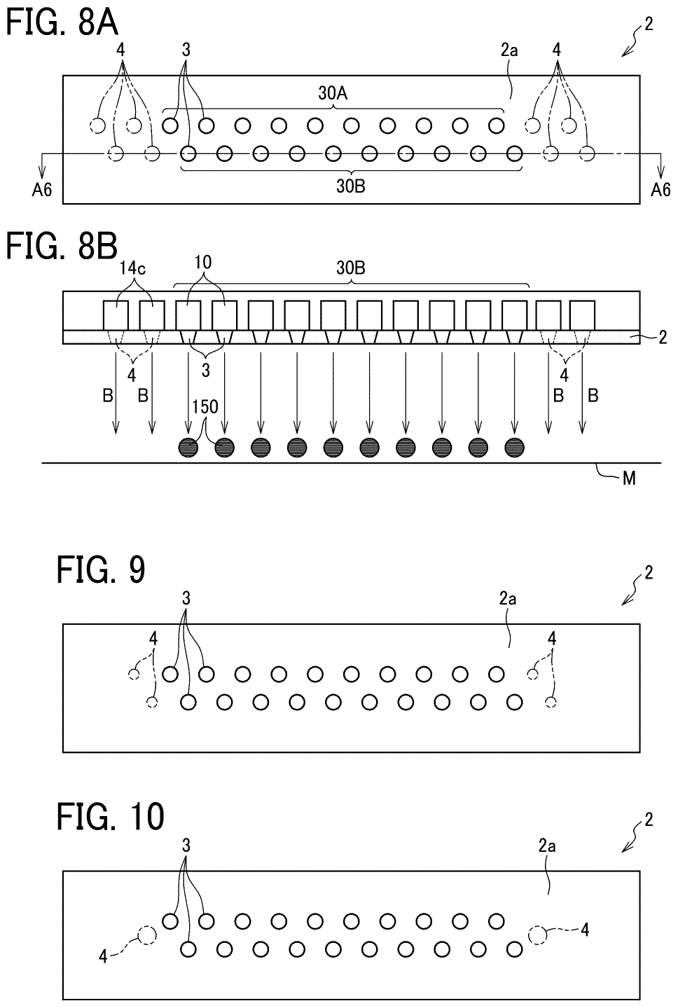

A liquid discharge head illustrated in FIGS. 8A and 8B includes two blow-out holes 4 disposed side by side in the longitudinal direction outside the outermost nozzles 3 in the longitudinal direction of each nozzle array. As compared with the embodiment of FIGS. 7A and 7B, this arrangement enlarges the range in the longitudinal direction in which a gas flow is formed from the blow-out holes 4. Thus, the displacement of the landing position of ink discharged from the nozzles 3 can be further inhibited. Therefore, for example, even with a large printing gap between a nozzle face 2a and a recording medium M, the displacement of the landing position of the ink can be inhibited. Alternatively, three or more blow-out holes 4 may be disposed side by side outside the nozzles 3 in the longitudinal direction.

A liquid discharge head illustrated in FIG. 9 includes blow-out holes 4 smaller in diameter than nozzles 3. The reduction of the blow-out holes 4 in diameter results in a decrease in the flow rate of gas blown out from the blow-out holes 4, but results in an increase in the flow velocity of the gas blown out therefrom. Therefore, the displacement of landing position due to, for example, a large influence of the gas flow can be effectively inhibited, and deterioration in the quality of an image formed on a recording medium M can be inhibited.

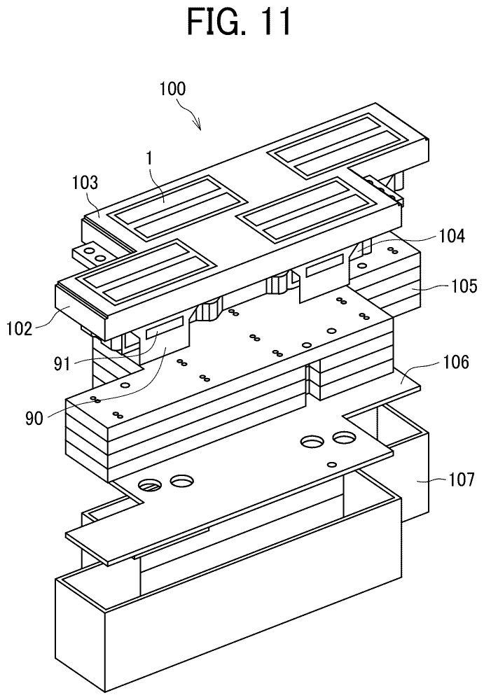

Alternatively, the blow-out holes 4 corresponding to all of the nozzle arrays are not necessarily provided. For example, a liquid discharge head illustrated in FIG. 10, one blow-out hole 4 and the other blow-out hole 4 are provided, respectively, to one end and the other end of a nozzle plate 2 between an upper nozzle array and a lower nozzle array. This arrangement results in reduction in the number of blow-out holes 4 and paths through which a gas flows, and results in reduction of the liquid discharge head in size and cost. In the present embodiment, the blow-out holes 4 are larger in diameter than nozzles 3. This arrangement results in a decrease in the flow velocity of gas blown out from the blow-out holes 4, but results in enlargement of the range in which the gas is blown out. Accordingly, even with such a small number of blow-out holes 4, the gas can flow in a wide range. However, in the present embodiment, the blow-out holes 4 may be equal in diameter to or may be smaller in diameter than the nozzles 3, or a plurality of blow-out holes 4 may be provided in the longitudinal direction as illustrated in FIGS. 8A and 8B.

Next, an exemplary method for producing a liquid discharge head including a blow-out hole is described.

A nozzle plate 2 of the present embodiment is formed of silicon. Thus, the nozzle plate 2 can be hole-processed with high accuracy, and a nozzle 3 and a blow-out hole 4 can be formed with high accuracy. The nozzle plate 2 can be alternatively formed of metal such as stainless steel or nickel, or can be alternatively formed of resin such as polyimide resin. First, such nozzles 3 and blow-out holes 4 as described above are formed in a silicon wafer with a thickness of 600 μm by photolithography and dry etching. Formation of the blow-out holes 4 by the same processing method as the nozzles 3 results in reduction or substantial elimination of the cost for providing the blow-out holes 4. The nozzles 3 are each 0.02 mm in diameter. Thereafter, the wafer is polished to a thickness of 100 μm, and cut into such nozzle plates 2 as described above by dicing. After the dicing, a water-repellent film is formed only on the respective ends of the nozzles 3 of each nozzle face 2a.

After a thickness of 0.6 um of SiO₂, a thickness of 1.5 μm of Si, and a thickness of 0.4 μm of SiO₂ are layered on the silicon wafer with a thickness of 600 μm to form a diaphragm having a three-layer structure. Thereafter, a thickness of 20 nm of Ti and a thickness of 200 nm of Pt are formed, as a lower electrode, over the diaphragm plate by sputtering.

A film with a thickness of 2 μm is formed over the lower electrode by a sol-gel method using an organometallic solution containing lead zirconate titanate (PZT), and then sintered at 700° C. to form a piezoelectric film of PZT. Thereafter, a thickness of 200 nm of Pt is formed, as an upper electrode, on the piezoelectric film by sputtering. After the formation of the upper electrode, the upper electrode, the piezoelectric film, and the lower electrode are patterned by dry etching to form a piezoelectric element 11 on the nozzle plate 2.

Next, each interlayer insulating film is formed on the upper electrode and the lower electrode by plasma chemical vapor deposition (CVD). Each contact hole is formed in the interlayer insulating film on the upper electrode and the interlayer insulating film on the lower electrode. Thereafter, a thickness of 50 nm of Ti and a thickness of 2 μm of Al are sequentially layered and dry-etched to form a wiring layer. Then, a portion of the diaphragm corresponding to an ink supply port is dry-etched to complete a wafer as the base of an individual liquid chamber substrate 5.

Next, a holding substrate is formed using a silicon wafer. The holding substrate has a holding substrate recess and a holding substrate opening serving to be a supply port. An epoxy-based adhesive with a film thickness of 2 μm is applied to a joint face of the prepared holding substrate wafer by a flexographic printer. The holding substrate was joined by curing the adhesive. Thereafter, the individual liquid chamber substrate 5 with a thickness of 600 μm is polished to a thickness of 80 μm. An individual liquid chamber 10 and a fluid resistance part are formed by inductively coupled plasma (ICP) dry etching. The wafer is formed into chips by dicing to complete the individual liquid chamber substrate 5. The individual liquid chamber substrate 5 has a connecter into which an electric signal is input from the outside. The wiring layer is drawn out to an end of the individual liquid chamber substrate 5, and a wiring board 16 described later is connected thereto.

A common liquid chamber substrate 6 including a common liquid chamber 12 for supplying ink to each individual liquid chamber 10 is provided upstream of the individual liquid chamber substrate 5. The common liquid chamber substrate 6 is formed by dry etching a silicon wafer.

A housing 7 can be made of resin such as epoxy resin or polyphenylene sulfide (PPS) resin, or may be made of metal such as stainless steel. Here, epoxy resin is used because of its inexpensiveness and lightweight. A liquid port 8 and a gas port 9 are provided to an upper portion of the housing 7.

The wiring board 16 is a flexible wiring board, and is electrically connected to the wiring of the individual liquid chamber substrate 5. Examples of the connecting method include soldering, anisotropic conductive film (ACF) connection, and non-conductive paste (NCP) connection. Here, NCP connection is adopted. A drive circuit is installed on the wiring board 16. If a drive circuit is on the individual liquid chamber substrate 5, the drive circuit is cooled. However, heat generation leads to a temperature distribution of the nozzle plate 2, and thus the discharge characteristics deteriorate. Therefore, in the present embodiment, the drive circuit is provided on the wiring board 16.

Then, the nozzle plate 2, the individual liquid chamber substrate 5, and the common liquid chamber substrate 6 are joined with the epoxy-based adhesive. The nozzle plate 2 and the individual liquid chamber substrate 5 may be joined by silicon direct bonding. Further, the common liquid chamber substrate 6 and the housing 7 are joined with the epoxy-based adhesive. The wiring board 16 is the flexible wiring board. The wiring board 16 is connected to an electric I/F 15 by, for example, soldering, and is drawn out from the electric I/F 15.

Next, an exemplary head module including a plurality of such liquid discharge heads as described above is described with reference to FIG. 11.

As illustrated in FIG. 11, a head module 100 includes a plurality of liquid discharge heads 1, a base 102, a cover 103, a heat dissipator 104, a manifold 105, a printed circuit board 106, and a module case 107.

The plurality of liquid discharge heads 1 are inserted into openings of the base 102, and the cover 103 joined and secured to the base 102 is joined with an adhesive to individual liquid chamber substrates of the liquid discharge heads 1.

The cover 103 has openings in regions corresponding to nozzles and blow-out holes on a nozzle face of a nozzle plate, and covers the peripheral edge of the nozzle face.

A channel provided to the manifold 105 is in communication with a liquid port of each liquid discharge head 1.

The printed circuit board 106 is electrically connected to a piezoelectric element of each liquid discharge head 1 through a flexible wiring member 90. A driver integrated circuit (IC) (drive circuit) 91 is mounted on the flexible wiring member 90.

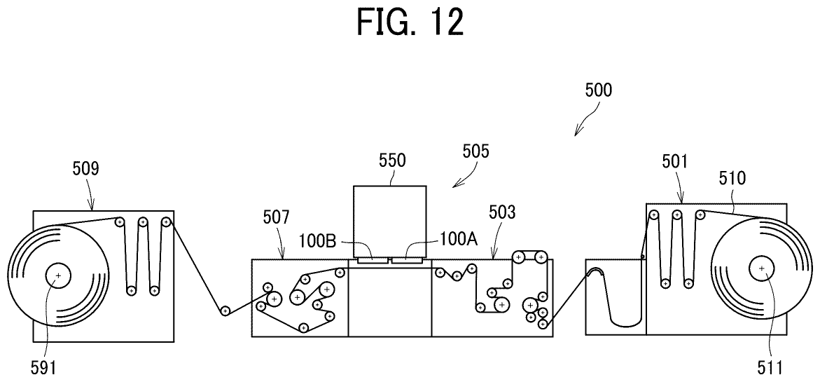

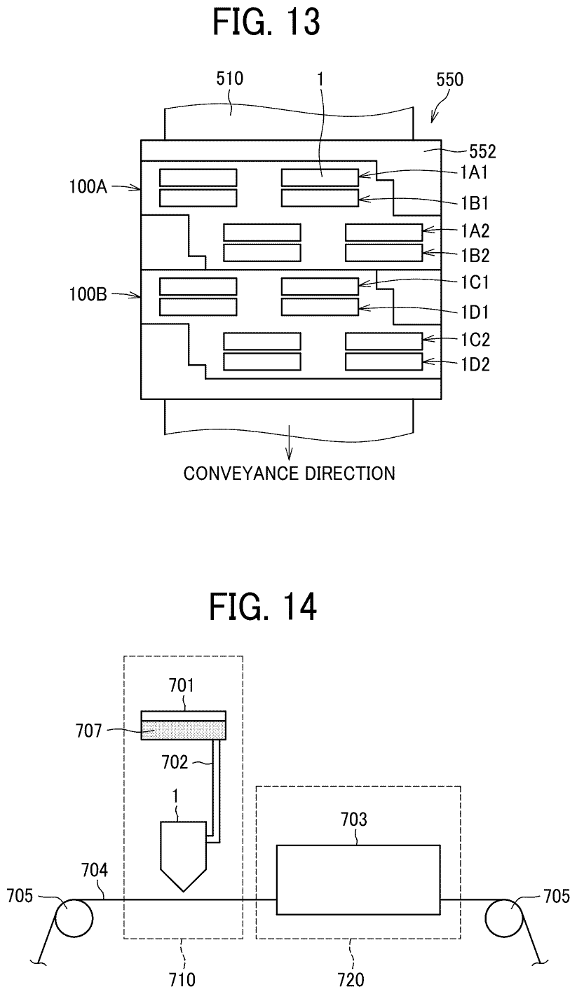

Next, an exemplary liquid discharge apparatus including the liquid discharge head or head module described above is described with reference to FIGS. 12 and 13.

As illustrated in FIG. 12, a printer 500 as a liquid discharge apparatus includes a carry-in unit 501, a guide conveyance unit 503, a printing unit 505, a drying unit 507, a carry-out unit 509, for example. The carry-in unit 501 carries a continuous material 510 into the guide conveyance unit 503. The guide conveyance unit 503 guides and conveys, to the printing unit 505, the continuous material 510 carried from the carry-in unit 501. The printing unit 505 discharges liquid onto the continuous material 510 to form an image. The drying unit 507 heats and dries the continuous material 510 after the image formation. The carry-out unit 509 carries out the dried continuous material 510.

The continuous material 510 is sent out from an original-roll roller 511 provided to the carry-in unit 501. Thereafter, the continuous material 510 is guided and conveyed by the carry-in unit 501, the guide conveyance unit 503, the drying unit 507, and the carry-out unit 509 to be wound around a winding roller 591 of the carry-out unit 509.

With the continuous material 510 facing a head unit 550 in the printing unit 505, ink is discharged from the liquid discharge head onto the continuous material 510 to print an image thereon.

As illustrated in FIG. 13, the head unit 550 includes three head modules 100A, 100B, and 100C, and a common base member 552 to which the head modules 100A, 100B, and 100C are provided.

Next, as a liquid discharge apparatus including the liquid discharge head or head module described above, an electrode and electrochemical element producing apparatus is described with reference to FIG. 14. FIG. 14 is a schematic view of an exemplary electrode producing apparatus according to an embodiment of the present disclosure. The electrode producing apparatus is an apparatus for producing an electrode including a layer containing an electrode material by discharging a liquid composition using a head module including a liquid discharge head.

A discharging unit included in the electrode producing apparatus illustrated in FIG. 14 is the head module according to the embodiment of the present disclosure. A liquid composition is discharged from the liquid discharge head of the head module. Thus, the liquid composition is applied onto a target, resulting in formation of a liquid composition layer. The target (hereinafter, may be referred to as “discharge target”) is not particularly limited, and thus may be appropriately selected depending on the intended purpose, as long as the target is a target on which a layer containing an electrode material is to be formed.

Examples of the discharge target include an electrode substrate (current collector), an active material layer, and a layer containing a solid electrode material. The discharge target may be an electrode mixture layer containing an active material on an electrode substrate (current collector). As long as a layer containing an electrode material can be formed on a discharge target, the discharging unit and the discharging process may be a unit and a process of forming a layer containing an electrode material by directly discharging a liquid composition. The discharging unit and the discharging process may be a unit and a process of forming a layer containing an electrode material by indirectly discharging a liquid composition.

Other configurations included in the apparatus for producing an electrode mixture layer are not particularly limited, and thus may be appropriately selected depending on the intended purpose, as long as the effects of the present disclosure are not impaired. Other processes included in the method for producing an electrode mixture layer are not particularly limited, and thus may be appropriately selected depending on the intended purpose, as long as the effects of the present disclosure are not impaired. For example, a heating unit and a heating process are examples of the configuration and the process included in the apparatus for producing the electrode mixture layer and the method for producing the electrode mixture layer.

The heating unit included in the apparatus for producing the electrode mixture layer is a unit that heats a liquid composition discharged by the discharging unit. The heating process included in the method for producing the electrode mixture layer is a process of heating a liquid composition discharged in the discharging process. The liquid composition is heated to dry the liquid composition layer.

As an exemplary electrode producing apparatus, an electrode producing apparatus for forming an electrode mixture layer containing an active material on an electrode substrate (current collector) is described below. As illustrated in FIG. 14, the electrode producing apparatus includes a discharging process unit 710 and a heating process unit 720. The discharging process unit 710 performs a discharging process including applying a liquid composition onto a printing base material 704 having a discharge target to form a liquid composition layer. The heating process unit 720 performs a heating process including heating the liquid composition layer to obtain an electrode mixture layer.

The electrode producing apparatus further includes a conveyor 705 that conveys the printing base material 704. The conveyor 705 conveys the printing base material 704 to the discharging process unit 710 and the heating process unit 720 in this order at a preset speed. A method for producing the printing base material 704 having the discharge target such as an active material layer is not particularly limited, and thus a known method can be appropriately selected. The discharging process unit 710 includes a liquid discharge head 1, a storage container 701, and a supply tube 702. The liquid discharge head 1 performs an application process of applying a liquid composition 707 onto the printing base material 704. The storage container 701 stores the liquid composition 707. The supply tube 702 supplies the liquid composition 707 stored in the storage container 701 to the liquid discharge head 1.

The discharging process unit 710 discharges the liquid composition 707 from the liquid discharge head 1 to apply the liquid composition 707 onto the printing base material 704, so that a liquid composition layer is formed in a thin film shape. The storage container 701 may be integrated with the electrode producing apparatus or may be detachable therefrom. The storage container 701 may include a container for adding the liquid composition 707 to the storage container 701 integrated with the electrode producing apparatus or to the storage container detachable from the electrode producing apparatus.

The storage container 701 and the supply tube 702 can be freely selected as long as the liquid composition 707 can be stably stored and supplied to the liquid discharge head 1.

The heating process unit 720 performs a solvent removal process of heating and removing the solvent remaining in the liquid composition layer. Specifically, the solvent remaining in the liquid composition layer is heated and dried by a heating device 703 of the heating process unit 720, so that the solvent is removed from the liquid composition layer. As a result, the electrode mixture layer is formed. The solvent removal process by the heating process unit 720 may be performed under reduced pressure.

The heating device 703 is not particularly limited, and thus may be appropriately selected depending on the intended purpose. For example, the heating device 703 may be a substrate heater, an infrared (IR) heater, or a hot air heater. The heating device 703 may be a combination of at least two of the substrate heater, the IR heater, and the hot air heater. A heating temperature and heating duration can be appropriately selected according to a boiling point of the solvent contained in the liquid composition 707 or the thickness of a formed film.

The electrode producing apparatus according to the embodiment of the present disclosure is used to discharge the liquid composition onto a desired place of the discharge target. The electrode mixture layer can be suitably used as, for example, part of the configuration of an electrochemical element. The configuration other than the electrode mixture layer in the electrochemical element is not particularly limited, and thus a known configuration can be appropriately selected. For example, as a configuration other than the electrode mixture layer, the electrochemical element may include a positive electrode, a negative electrode, and a separator.

Application of the liquid discharge head described above to the above-described head module or liquid discharge apparatus results in assurance of the maintainability of the liquid discharge head and results in inhibition of the displacement of the landing position of liquid.

Note that numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims.

In the present application, discharged liquid is not limited to a particular liquid as long as the liquid has a viscosity or surface tension to be discharged from a head. However, preferably, the viscosity of the liquid is not greater than 30 mPa·s under ordinary temperature and ordinary pressure or by heating or cooling. Examples of the liquid include a solution, a suspension, or an emulsion including, for example, a solvent, such as water or an organic solvent, a colorant, such as dye or pigment, a functional material, such as a polymerizable compound, a resin, a surfactant, a biocompatible material, such as deoxyribonucleic acid (DNA), amino acid, protein, or calcium, and an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

The term “liquid” includes not only ink but also paint, a pretreatment liquid, a binder, and an overcoat liquid.

In the present application, a “liquid discharge apparatus” is an apparatus that includes a carriage including a liquid discharge head and discharges liquid by driving the liquid discharge head. The term “liquid discharge apparatus” used herein includes, in addition to apparatuses to discharge liquid to materials onto which liquid can adhere, apparatuses to discharge the liquid into gas (air) or liquid.

The “liquid discharge apparatus” may include devices to feed, convey, and eject a material onto which liquid can adhere. The liquid discharge apparatus may further include a pretreatment apparatus to coat a treatment liquid onto the material, and a post-treatment apparatus to coat a treatment liquid onto the material, onto which the liquid has been discharged.

The “liquid discharge apparatus” may be, for example, an image forming apparatus to form an image on a paper sheet by discharging ink, or a three-dimensional fabrication apparatus to discharge a fabrication liquid to a powder layer in which a powder material is formed in layers to form a three-dimensional fabrication object.

The term “liquid discharge apparatus” is not limited to an apparatus to discharge liquid to visualize meaningful images, such as letters or figures. For example, the liquid discharge apparatus may be an apparatus to form meaningless images, such as meaningless patterns, or fabricate three-dimensional images.

The term “material onto which liquid can adhere” is a material onto which liquid at least temporarily adheres, a material onto which liquid adheres to be fixed, or a material onto which liquid adheres to permeate into the material. The term “material onto which liquid can adhere” represents a recording medium in the embodiments described above. Examples of the “material onto which liquid can adhere” include recording media, such as paper sheet, recording paper, recording sheet of paper, film, and cloth, electronic component such as electronic substrate and piezoelectric element, and media such as powder layer, organ model, and testing cell. The “material onto which liquid can adhere” includes any material onto which liquid can adhere, unless particularly limited.

Examples of the “material onto which liquid can adhere” include any materials onto which liquid can adhere even temporarily, such as paper, thread, fiber, fabric, leather, metal, plastic, glass, wood, and ceramic.

Examples of the liquid discharge apparatus further include: a treatment liquid applying apparatus that discharges a treatment liquid onto a paper sheet to apply the treatment liquid to the surface of the paper sheet, for reforming the surface of the paper sheet; and an injection granulation apparatus that injects a composition liquid, in which a raw material is dispersed in a solution, through a nozzle to granulate fine particle of the raw material.

The terms “image formation”, “recording”, “printing”, “image printing”, and “fabricating” used herein may be used synonymously with each other.

Aspects of the present disclosure are, for example, as follows.

### Aspect 1

According to Aspect 1, a liquid discharge head includes: a nozzle member including: a plurality of nozzles to discharge liquid; and a blow-out hole to blow out gas. The blow-out hole is closer to an end in a longitudinal direction of the nozzle member than a nozzle closest to the end in the longitudinal direction of the nozzle member among the plurality of nozzles.

### Aspect 2

According to Aspect 2, in the liquid discharge head of Aspect 1, the blow-out hole is equal in diameter to each one of the plurality of nozzles.

### Aspect 3

According to Aspect 3, in the liquid discharge head of Aspect 1, the blow-out hole is smaller in diameter than each one of the plurality of nozzles.

### Aspect 4

According to Aspect 4, in the liquid discharge head of any one of Aspects 1 to 3, the nozzle member further includes another blow-out hole to blow out gas. The other blow-out hole is provided closer to another end in the longitudinal direction of the nozzle member than a nozzle closest to the other end in the longitudinal direction of the nozzle member among the plurality of nozzles.

### Aspect 5

According to Aspect 5, the liquid discharge head of any one of Aspects 1 to 4 further includes a channel member including a liquid channel in communication with the plurality of nozzles. The channel member includes a gas path in communication with the blow-out hole.

### Aspect 6

According to Aspect 6, the liquid discharge head according to any one of Aspects 1 to 5 further includes a plurality of blow-out holes, including the blow-out hole, disposed side by side in the longitudinal direction. The plurality of blow-out holes are closer to the end in the longitudinal direction of the nozzle member than the nozzle closest to the end in the longitudinal direction of the nozzle member among the plurality of nozzles.

### Aspect 7

According to Aspect 7, a head module includes a plurality of liquid discharge heads, each of which is the liquid discharge head according to any one of Aspects 1 to 6.

### Aspect 8

According to Aspect 8, a liquid discharge apparatus includes the liquid discharge head according to any one of Aspects 1 to 6.

1. A liquid discharge head, comprising:
a nozzle member including:
a plurality of nozzles to discharge liquid; and
a blow-out hole to blow out gas,
wherein the blow-out hole is closer to an end in a longitudinal direction of the nozzle member than a nozzle closest to the end in the longitudinal direction of the nozzle member among the plurality of nozzles is.

2. The liquid discharge head according to claim 1,
wherein the blow-out hole is equal in diameter to each one of the plurality of nozzles.

3. The liquid discharge head according to claim 1,
wherein the blow-out hole is smaller in diameter than each one of the plurality of nozzles.

4. The liquid discharge head according to claim 1,
wherein the nozzle member further includes another blow-out hole to blow out gas, and
said another blow-out hole is closer to another end in the longitudinal direction of the nozzle member than a nozzle closest to said another end in the longitudinal direction of the nozzle member among the plurality of nozzles is.

5. The liquid discharge head according to claim 1, further comprising a channel member including a liquid channel in communication with the plurality of nozzles,
wherein the channel member includes a gas path in communication with the blow-out hole.

6. The liquid discharge head according to claim 1, further comprising a plurality of blow-out holes, including the blow-out hole, disposed side by side in the longitudinal direction,
wherein the plurality of blow-out holes are disposed closer to the end in the longitudinal direction of the nozzle member than the nozzle closest to the end in the longitudinal direction of the nozzle member among the plurality of nozzles is.

7. A head module, comprising a plurality of liquid discharge heads, each one of which is the liquid discharge head according to claim 1.

8. A liquid discharge apparatus, comprising the liquid discharge head according to claim 1.
